(19) United States
(12) Patent Application Publication
(10) Pub. No.: US 2025/0156776 A1
(43) Pub. Date: May 15, 2025

(54) EXPEDITED OPERATIONS RESOLUTION

(71) Applicant: Kyndryl, Inc., New York, NY (US)

(72) Inventors: KALPESH SHARMA, BANGALORE (IN); Veeresh Bushetti, Savanur (IN); Nalini M, CHENNAI (IN)

(21) Appl. No.: 18/388,579

(22) Filed: Nov. 10, 2023

(51) Int. Cl. G06Q 10/0631

(52) U.S. Cl. CPC G06Q 10/06311

(57) ABSTRACT

A computer-implemented method, including: receiving, by a computing device, an information technology (IT) operations request; collecting, by the computing device, information associated with the IT operation request from a knowledge bank; determining, by the computing device, a resolution resource for completing the IT operation request; and assigning, by the computing device, the resolution resource based on the information from the knowledge bank and IT operation request.

### BACKGROUND

Aspects of the present invention relate generally to information technology (IT) operations management (ITOM) for expedited resolution of IT issues.

### SUMMARY

In a first aspect of the invention, there is a computer-implemented method including: receiving, by a computing device, an information technology (IT) operations request; collecting, by the computing device, information associated with the IT operation request from a knowledge bank; determining, by the computing device, a resolution resource for completing the IT operation request; and assigning, by the computing device, the resolution resource based on the information from the knowledge bank and IT operation request.

In another aspect of the invention, there is a computer program product including one or more computer readable storage media having program instructions collectively stored on the one or more computer readable storage media. The program instructions are executable to: receive an information technology (IT) operations request; collect information associated with the IT operation request from a knowledge bank; determine a resolution resource for completing the IT operation request; assign the resolution resource based on the information from the knowledge bank and IT operation request; and schedule a solution to the IT operation request with the resolution resource.

In another aspect of the invention, there is system including a processor, a computer readable memory, one or more computer readable storage media, and program instructions collectively stored on the one or more computer readable storage media. The program instructions are executable to: receive an information technology (IT) operations request; collect information associated with the IT operation request from a knowledge bank; generate a current state of environment of the IT operation request based on the information in the knowledge bank; determine a resolution resource for completing the IT operation request based on at least availability of the resolution resource and the current state; assign the resolution resource based on the information from the knowledge bank and IT operation request; and schedule a solution to the IT operation request with the resolution resource.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary expedited operations resolution environment in accordance with aspects of the present invention.

FIG. 5 shows a flowchart of objects and steps taken of an exemplary method in accordance with aspects of the present invention.

FIG. 6 shows a flowchart of objects and steps of an exemplary method executed by an exemplary expedited operation management device in accordance with aspects of the present invention.

FIG. 7 shows a flowchart of objects and steps taken of an exemplary method in accordance with aspects of the present invention.

FIG. 8 shows a flowchart of an exemplary method in accordance with aspects of the present invention.

FIG. 9A shows a flowchart of assignments to different resolution resources in accordance with aspects of the present invention.

FIG. 9B shows communications between an expedited operation management device and resolution resources during the assignments in accordance with aspects of the present invention.

FIG. 9C shows knowledge base information and its utilization in steps of the exemplary method in accordance with aspects of the present invention.

FIG. 10 shows a resolution window including resolution resource unit lifecycles in accordance with aspects of the present invention.

### DETAILED DESCRIPTION

Aspects of the present invention relate generally to information technology (IT) operations management (ITOM) and, more particularly, to expedited resolution of IT issues. In this manner, implementations of the invention provide optimal assignment and scheduling of resolution resources to complete an IT operation request. For example, information associated with a patterning of IT operation requests, resolution resources, and other information associated with the IT operation request may be utilized to assign and schedule the completion of the IT operation request. An expedited resolution system can be created by taking into consideration the information associated with the patterning of IT operation request, the resolution resources, and the other information associated with the IT operation request. In the expedited operation resolution system, the IT operation request may be assigned to a resolution resource and scheduled with a solution while predicting and triaging issues raised by the IT operation requests. In addition, the expedited operation resolution system provides expedited turnaround time and optimal utilization of available resources.

Implementations of the invention include a method and system for expediting the turnaround time of an IT operation request. Further, the method and system utilizes artificial intelligence to dynamically infuse expedited responses through information technology (IT) operations management. In addition, the method and system achieves just-in-time responses or quick responses to resolve reported incidents. In particular, the method and system utilizes a data-driven approach to determine a best possible schedule for any system as a service (SaaS). The method and system also maintains multiple aspects, such as a nature of a fix, a resolution resource contributing to the fix, the resolution resource experience, availability, etc. The method and system further expedites responses and resolutions by infusing intrinsic pressure (i.e., create pressure to complete the IT operation request, the pressure being created by parties within the system itself). This intrinsic pressure may be created via escalation of response to the IT operation request in a development ecosystem, and using this intrinsic pressure to lead system-originated escalation across parallel working units (e.g., resolution resource) in a pre-escalation heads-up mode (i.e., notification of a potential escalation prior to actual escalation of the response); performs constant polling of best available skills of resolution resources and re-assignment to another resolution resource to expedite responses and resolutions to an IT operation request; and utilize a multivariate classification to categorize resolution resources across multiple buckets and subsequently triage, prioritize, and assign an IT operation request to a best possible resolution resource to expedite resolution.

Implementations of the invention provide an improvement in the technical field of information technology operations management (ITOM) by providing a technical solution to a problem of addressing second day operations (e.g., maintenance, monitoring, optimization of products in a product lifecycle) in an efficient manner without compromising quality and standards of the work product (i.e., work of the resolution resource such as coding that may be used to solve the IT operation request). In embodiments, the technical solution may include, amongst other features: receiving an information technology (IT) operation request and information associated with the IT operation request from a knowledge bank; determining a resolution resource for completing the IT operation request; and assigning the resolution resource based on the information associated with the IT operation request and the IT operation request. These steps allow an expedited operation resolution system to better assign and schedule resolution of IT operation request with resolution resources and optimally utilize resources without compromising quality and standards.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

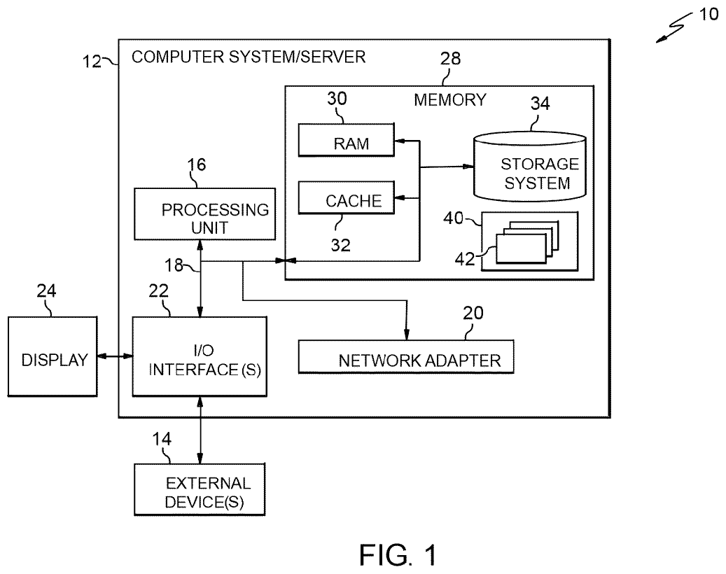

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

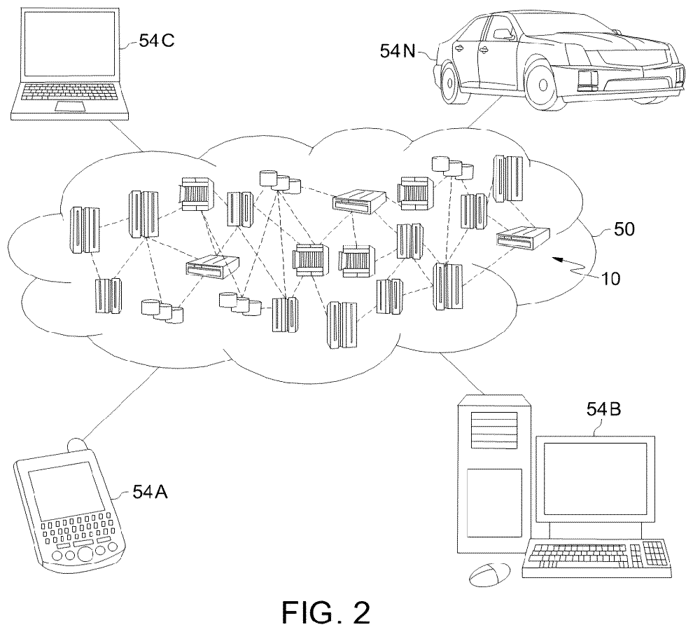

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

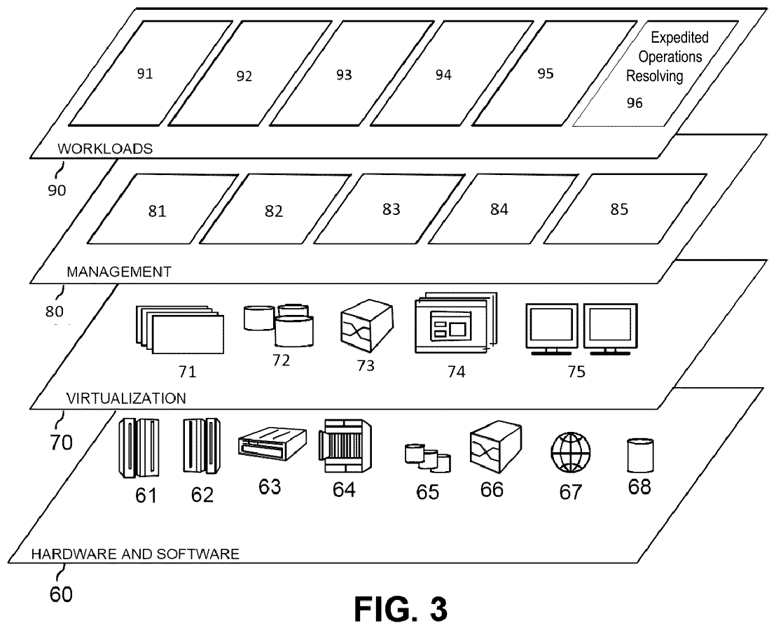

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below.

Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and expedited operations resolution 96.

Implementations of the invention may include a computer system/server 12 of FIG. 1 in which one or more of the program modules 42 are configured to perform (or cause the computer system/server 12 to perform) one of more functions of the expedited operations resolution 96 of FIG. 3. For example, the one or more of the program modules 42 may be configured to, amongst other features: (i) receive an information technology (IT) operations request; (ii) collect information associated with the IT operation request from a knowledge bank; (iii) determine a resolution resource for completing the IT operation request; (iv) assign the resolution resource based on the information from the knowledge bank and IT operation request; and (v) schedule a solution to the IT operation request with the resolution resource.

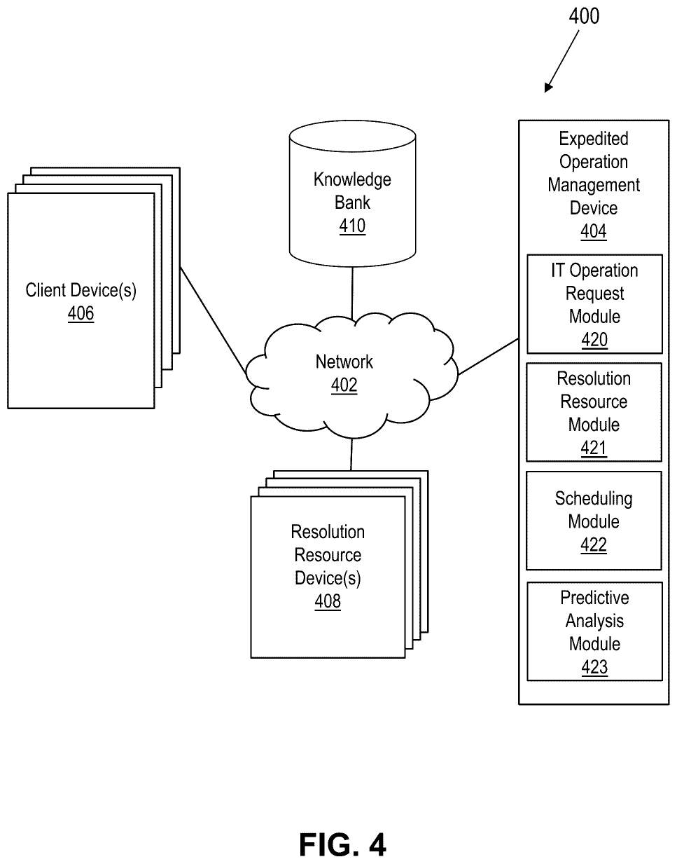

FIG. 4 shows a block diagram of an exemplary expedited operation resolution environment in accordance with aspects of the present invention. In embodiments, the expedited operation resolution environment 400 includes a network 402 enabling communication between expedited operation management device 404, client device 406, resolution resource device 408, and knowledge bank 410. In embodiments, the expedited operation management device 404, the client device 406, and the resolution resource device 408 may each comprise a computing device (e.g., the computer system/server 12 of FIG. 1, or elements therefor) in a networked environment and/or a computing node 10 in the cloud computing environment 50 of FIG. 2 and/or one or more program modules such as program modules 42 described with respect to FIG. 1.

In embodiments, the client device 406 may supply IT operation requests for issues, incidents, events, or alerts to the expedited operation management device 404. The expedited operation management device 404 may be a platform (i.e., one or more server computing devices) that hosts the execution of the IT operation management. The resolution resource device 408 includes one or more computing devices (i.e., one or more server computing devices) hosting resolution resources (e.g., developers or subject matter experts (SMEs)) that will be utilized by the expedited operation management device 404 to resolve the IT operation request.

In embodiments, the expedited operation management device 404 comprises an IT operation request module 420, resolution resource module 421, scheduling module 422, and predictive analysis module 423, each of which may comprise one or more program modules such as program modules 42 described with respect to FIG. 1. The expedited operation management device 404 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments, the IT operation request module 420 is configured to receive IT operation requests (e.g., production defect reports/tickets). In exemplary embodiments, the IT operation request module 420 also sends the IT operation requests to the knowledge bank 410 for storing. In an exemplary embodiment, the IT operation request module 420 may also manage and collect details of historical IT operation request for comparison with received IT operation requests to identify an IT operation request pattern for optimal completion (i.e., effective and efficient resolution to the IT operation request). In exemplary embodiments, the IT operation request module 420 is configured to utilize artificial intelligence (AI) and/or machine learning (ML) models to identify the IT operation request pattern. In embodiments, the ML model is a hierarchical or k-means clustering. In embodiments, the ML model of the IT operation requests receive training inputs of historical IT operation requests and results of the assignment to particular resolution resources and solution provided by the resolution resource. These training inputs may include an issue type, an issue severity, an expected time of response, an impacted area (i.e., which systems, applications, modules, products, etc. are affected by the issue), a resolution timeline, utilized solution, an escalation template, issue report time, and information associated with the utilized resolution resource. In exemplary embodiments, these training inputs may also be utilized by other potential algorithms and to identify patterns in the IT operation requests.

In embodiments, the resolution resource module 421 is configured to utilize AI and/or ML models to determine a resolution resource that optimally completes the IT operation requests (i.e., effectively and efficiently resolving IT operation request). In embodiments, the ML model is a multivariate classification model. In embodiments, the ML model of the resolution resource module 421 determines patterns to categorize resolution resources across multiple buckets and subsequently triage, prioritize, and assign an IT operation request to optimize and expedite resolution by an appropriate resolution resource.

In embodiments, the ML model establishes a pattern associated with physical availability of the resolution resource (i.e., closeness). For example, a resolution resource may be physically located near a client system of the IT operation request and/or be near a resolution resource device 408 to digitally access the client system. This physical location may be utilized to determine immediate and/or short-term availability of a resolution resource.

The training inputs of the ML model may include resolution resource information that contributes to a selection of the resolution resource, including, but not limited to an availability information of the resolution resource and resolution resource information associated with the resolution resource. In embodiments, the availability information includes, but is not limited to one or more of: a physical location of the resolution resource (e.g., access to the client location or resolution resource device with access to the client system of the IT operation request), a work time zone of the resolution resource, a leave plan of the resolution resource, historical ticket assignments of the resolution resource, developer platform data (for example, Github activity) for the resolution resource, and total resource bandwidth for the resolution resource (e.g., whether the resolution resource has bandwidth to take on additional work).

In embodiments, the resolution resource information includes, but is not limited to one or more of: application and technology skill of the resolution resource (i.e., matching of resolution resource skills to the presumed skills associated with the IT operation request), historical issues completed by the resolution resource (i.e., based on matching of IT operation requests to one another to determine which IT operation request may be completed together), areas of expertise of the resolution resource (i.e., where a resolution resource had previously worked (i.e., client sites)), usage statistics of the resolution resource (i.e., matching of the skills utilized by the resolution resources and the effectiveness of their use such as success rate), historical resolution resource skills utilized (i.e., matching of the skills utilized by the resolution resources), resolution time of completion by the resolution resource (i.e., matching of the time it takes the resolution resource to complete similar IT operation requests), historical reassignments of IT operation request and/or reasons for reassignment (i.e., whether, when, and why re-assignment of the IT operation request was made), reassignment effects (e.g., how a resolution resource handles reassignment), issue correlations (e.g., issues that may be related to one another), interaction information (of the resolution resource with other parties, i.e., how a resolution resource works with other resolution resources and whether joint handling of the IT operation request resulted in a faster/more successful solution), solution application to a plurality of issues (i.e., whether a solution applied to multiple IT operation requests), comparison to other resolution resource statistics (i.e., comparing time to completion, repetition of solutions before completion, etc.), solution approaches (i.e., repository utilization, client and client location (i.e., who the clients are and owners of the product), infrastructure solutions (i.e., whether solutions were related to client system adjustments such as a client needing a virtual machine memory clean up), leave plan handling (e.g., backup plans for when clients are out of office), and time to production (e.g., whether clients historically process the product more quickly through the SDLC after the solution is implemented).

In embodiments, based on the resolution resource information, a success rate and confidence score of resolving the IT operation requests for each resolution resource may be determined. In embodiments, the ML model is utilized in mapping (i.e., comparing and matching) information associated with the resolution resource to information associated with the IT operation request. For example, a resolution resource with technology skills that do match the IT operation request, but resolution time that would extend beyond a client's time to production would not be selected unless no other resolution resources could even match the technology skills.

In embodiments, the availability information of the resolution resource and resolution resource information are utilized to determine a best available resolution resource for completion of the IT operation requests. In embodiments, the ML model of the resolution resource prioritizes and assigns the IT operation request to the resolution resource.

In an exemplary embodiment, the resolution resource module 421 analyzes the IT operation request to determine, for example, technical skills required to complete the IT operation request, and identify associated information related the IT operation request. In the exemplary embodiment, a success rate and confidence score in success for each resolution resource is determined. For example, each resolution resource may include a confidence level of low, medium or high) based on the confidence score with regards to whether the resolution resource is able to complete the IT operation request. Further, in the exemplary embodiment, a pattern is identified to determine how near, i.e., physical or digital proximity, the resolution resource is to the client system associated with the IT operation request (i.e., closeness). For example, a resolution resource may be near the client system, away from the client system, or is included in the client system. The pattern may determine availability to implement a solution. Additionally, in the exemplary embodiment, the leave plans, work shift, and total resource bandwidth of the resolution resources are utilized to determine who is available to work on the IT operation request. For example, resolution resources may be determined to be available, not available, or booked. If a resolution resource is booked, further determination may be made to determine whether that resolution resource may re-prioritize the booking (i.e., the IT operation request the resolution resource is currently working on) to a different time. In further exemplary embodiments, all resolution resource information may be utilized in a multivariate analysis to establish solutioning patterns for each of the resolution resources. For example, a resolution resource may include at least previously worked on modules, expertise level with those modules and success rates of each historical module. In particular, these features may be utilized to determine which resolution resource matches the IT operation request, and thus, should be assigned to the IT operation request.

In embodiments, the resolution resource module 421 continuously polls for a best available resolution resource. For example, the resolution resource module 421 may verify whether the IT operation requests are incomplete and continuously polls for changing availability of resolutions resources. As resolution resources become available or are occupied, the selected resolution resource may change. Thus, the IT operation requests may be reassigned to the newly selected resolution resource based on availability. For example, an IT operation request may be assigned to one resolution resource. However, new information from the continued polling (based on the status of the IT operation request being ‘in progress’ and not completed) may show that another resolution resource is now available (i.e., a resolution resource that better matches the IT operation request, except was not previously available). Thus, the IT operation request may be re-assigned to the other resolution resource. The status of the IT operation request may continue to be ‘in progress’ and not completed. In this scenario, another new resolution resource better suited for the completion may be available. Thus, the IT operation request is again re-assigned to the new resolution resource until the IT operation request is completed. In exemplary embodiments, the ‘in progress’ status may include further differentiation to determine whether the assigned resolution resource has begun work on the IT operation request.

In embodiments, the resolution resource module 421 may assign the IT operation request and notify a selected resolution resource of an assignment via various communications channels. In embodiments, should the resolution resource not confirm assignment or respond that they are unavailable to complete the IT operation request, the resolution resource module 421 re-assigns the IT operation request to another resolution resource and notifies the other resolution resource of the re-assignment of the IT operation request.

In embodiments, the scheduling module 422 is configured to schedule the IT operation request for the determined resolution resource from the resolution resource module 421. In embodiments, the scheduling module 422 bases the scheduling of the IT operation request on a categorization of the IT operation request based on severity and/or business impact to the client. In embodiments, the scheduling also utilizes the availability of the resolution resource to take on the additional work and/or determine whether some or all of the current work bandwidth of the resolution resource may be re-prioritized after the IT operation request. In embodiments, the scheduling module 422 bases the scheduling of the solution on scheduling information including at least one of: an urgency of the rollout of the product associated with the IT operation request, a deployment type of the product (i.e., what type of organization the deployment is applicable to), a solution delivery type (i.e., how the solution is delivered to the client), a maintenance type (i.e., how disruptive to client systems, the solution will be), and customer working hours (i.e., when the client will be available for the solution to be implemented and/or the time before the customer needs to utilize the solution). For example, urgency of the rollout may include different levels such as blocker, critical, moderate, or low to indicate importance of a solution to the IT operation request. Blocker type urgencies would require immediate address by the scheduling module 422. Moderate and low urgency could be scheduled at later formal deployment windows. Additionally, for example, a deployment type may be for a dedicated client, private, public, or hybrid systems. Further, outer facing deployments would be prioritized over private or dedicated deployments.

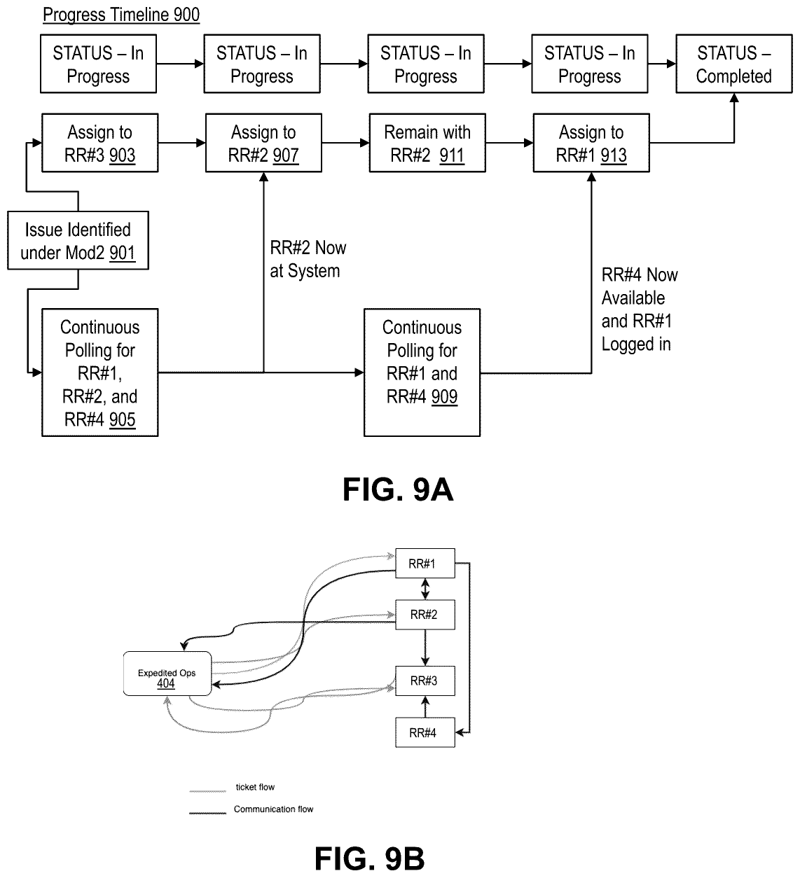

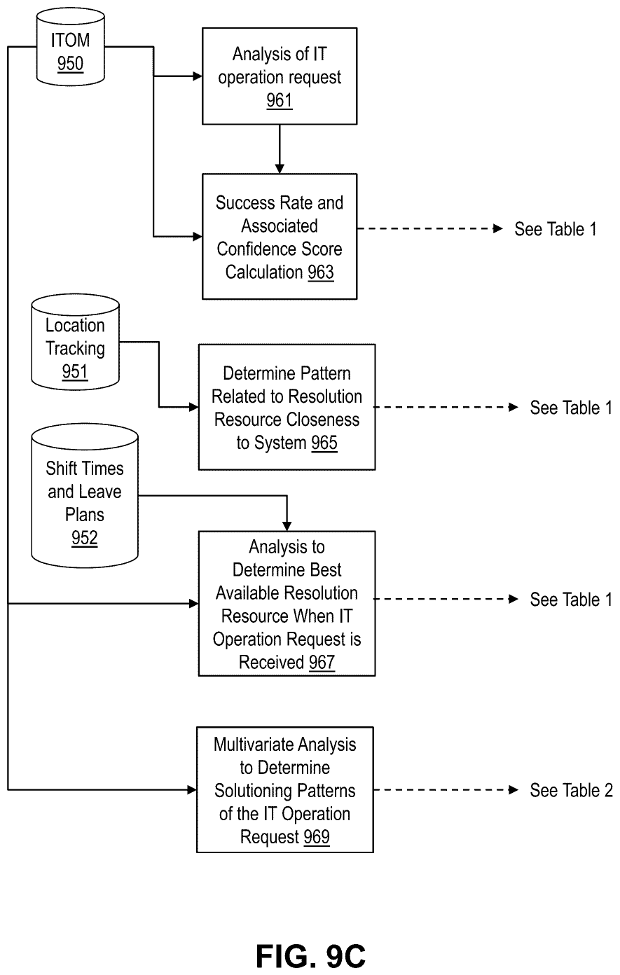

In embodiments, the prioritization may also be determined from an escalation template that identifies backup plans for a failure and/or an increasing number or level of contacts (i.e., escalating contacts for providing information about incompletion of the IT operation request to provide system pressure to complete the IT operation request) for continued incompletion of the IT operation request. In embodiments, as the IT operation request remains incomplete, the scheduling module 422 generates artificial intrinsic pressure (i.e., through escalation of the IT operation request) in the software development lifecycle (SDLC) to trigger further action on the IT operation request. These actions may escalate with the resolution resource and/or additional resolution resources that may previously have an early notification of potential escalation. This escalation may be further described in the description of FIG. 9. In embodiments, while the IT operation request is incomplete, the scheduling module 422 may track the time to resolution. However, the time to resolution may toll while a client response is requested. In embodiments, the escalation may track the resolution resources required to complete the IT operation request. For example, an IT operation request may require multiple parties to resolve the IT operation request. In such an example, an IT operation request may be investigated by one team/member (i.e., the team/member reviews the IT operation request) to determine whether additional resolution resources are required to complete the IT operation request. Additionally, that reviewing team/member may determine another team/member that is needed to complete the IT operation request. The IT operation request is passed to the other team/member, which escalates and manages the completion of the IT operation request.

In embodiments, service level agreement (SLA) terms (e.g., an SLA time) with the client may be an additional input to reduce a potential for breach of the SLA terms. In embodiments, the scheduling module 422 utilizes a reinforcement learning model that further utilizes the historical IT operation requests to track and update known historical IT operation requests and the resource usage.

In embodiments, the predictive analysis module 423 is configured to predict potential issues that may affect a client before issues occur. In embodiments, the predictive analysis module 423 tracks actions in the SDLC environment to track a current state and predict potential issues based on the current state of products in the SDLC environment.

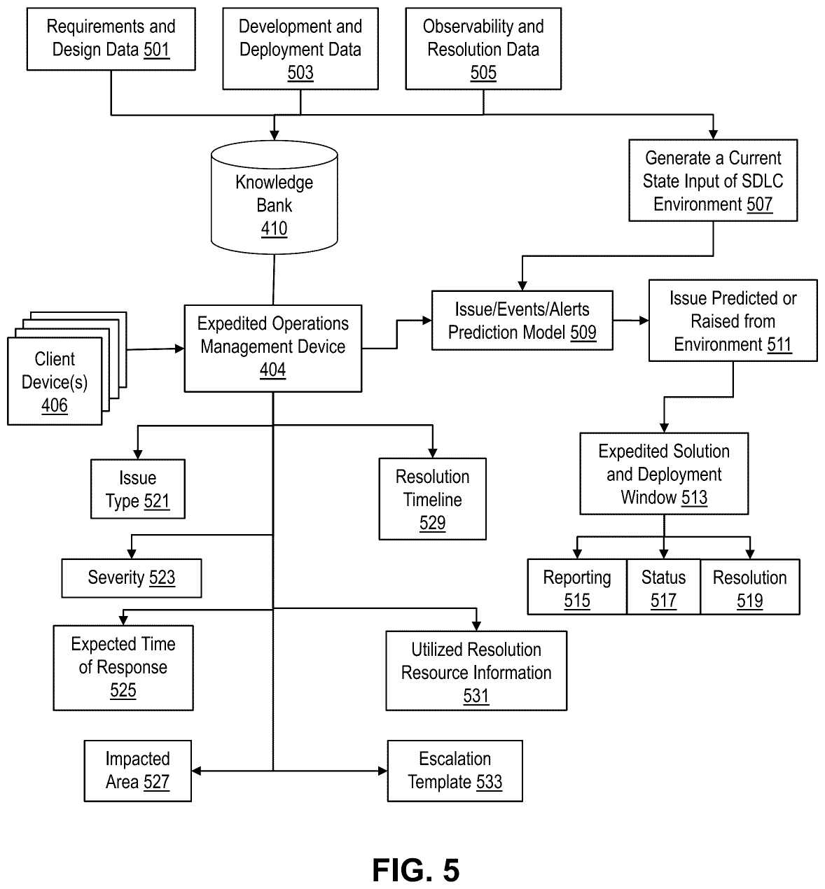

FIG. 5 shows a flowchart of objects and steps taken of an exemplary method in accordance with aspects of the present invention. Steps of the method may be carried out in the environment of FIG. 4 and are described with reference to elements depicted in FIG. 4. In embodiments, the expedited operation management device 404 receives various IT operation request from client device 406. The expedited operation management device 404 may access and manage a knowledge bank 410 and collect reported data of solutions to the IT operation request. The knowledge bank 410 may collect and store information about IT operations with clients including requirements and design data 501, development and deployment data 503, and observability and resolution data 505 of product data in an SDLC. In embodiments, the product data may include client asset details and associated metrics including network connectivity of assets, client connection status, deployment status and logs, infrastructure environment logs, and parties of the latest deployments. In embodiments, the expedited operation management device 404 may generate a current state input of the SDLC environment 507 of the product data from the knowledge bank 410 to issues/events/alerts prediction model 509. Thus, potential issues may be predicted with a client.

In embodiments, an issue prediction or raised from the environment 511 may utilize received IT operation request or predicted issues to generate requests that are managed by the expedited operation management device 404. In embodiments, the expedited operation management device 404 assigns and deploys a solution to the IT operation request or predicted issue via an expedited solution and deployment window 513. In embodiments, the expedited solution and deployment window 513 may provide resolution resources with options to configure solutions to the IT operation request and/or predicted issue. The solution and process of providing a solution is tracked by the expedited operation management device 404 and provides reporting 515 (e.g., resolution resources utilized, reassignments, etc.), status 517 (e.g., completion and incompletion), and resolution 519 (e.g., time taken, other issues affected, etc.) are tracked for all actions and inactions on the IT operation request and predicted issue. These reports may include IT operation request information including one or more of: an issue type 521, an issue severity 523, an expected time of response 525, an impacted area 527, a resolution timeline 529, utilized resolution resource information 531, an escalation template 533 for the IT operation request, issue report time, and the utilized resolution resource information 531.

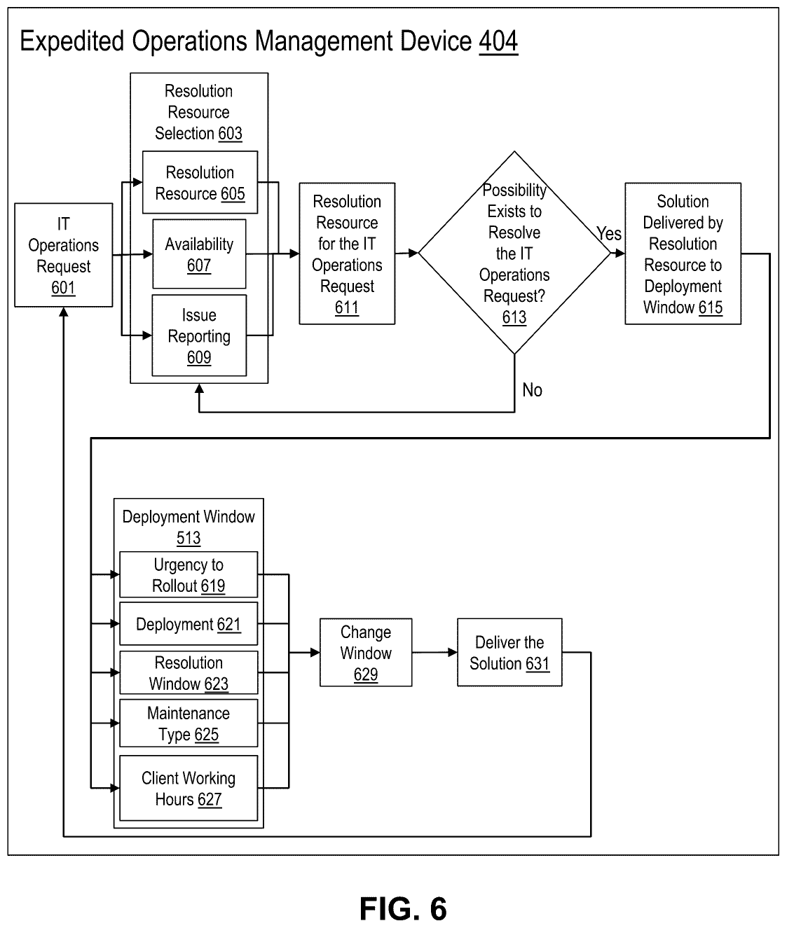

FIG. 6 shows a flowchart of objects and steps of an exemplary method executed by an exemplary expedited operation management device 404 (also shown in FIG. 4) in accordance with aspects of the present invention. Steps of the method may be carried out in the environment of FIG. 4 and are described with reference to elements depicted in FIG. 4. In embodiments, the expedited operation management device 404 receives an IT operation request 601. In embodiments, the IT operation request 601 is utilized, along with information from a knowledge bank 410 to provide a resolution resource selection 603. In embodiments, the resolution resource selection 603 selects a resolution resource 605 from a set of resolutions resources (e.g., developers or subject matter experts (SMEs) that will address/resolve the IT operation request 601). In embodiments, the availability 607 is tracked to determine which resolution resource is currently available to resolve the IT operation request 601. In embodiments, the availability 607 provides issue reporting 609 to track status and actions/inaction with the knowledge bank 410.

In embodiments, the resolution resource for the IT operation request 611 is selected and assigned the IT operation request. In embodiments, a determination is made regarding whether a possibility exists to resolve the IT operation request 613 by the selected resolution resource. If the resolution resource is unavailable or determined to be unlikely to complete the IT operation request, the resolution resource selection 603 may continually occur. If the resolution resource is likely to complete the IT operation request, then the IT operation request is assigned to the resolution resource and a solution is delivered by the resolution resource via a deployment window 615 (e.g., deployment window 513 of FIG. 5).

In embodiments, deployment window 513 determines urgency of rollout 619, deployment 621, resolution window 623, maintenance type 625 of the solution, and client working hours 627 to provide configuration options for a solution deployed to complete the IT operation request. In embodiments, the resolution resource utilizes a change window 629 to make any adjustments to the solution. In embodiments, the expedited operation management device 404 is configured to deliver the solution 631 to the client.

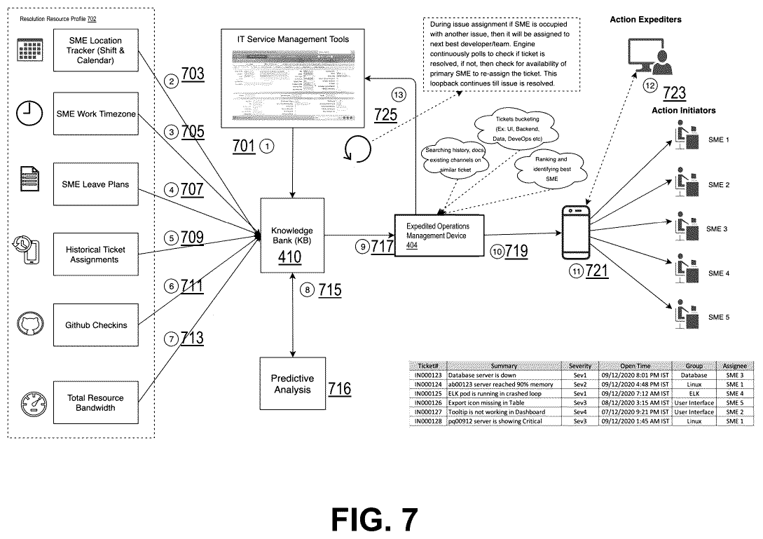

FIG. 7 shows a flowchart of objects and steps taken of an exemplary method in accordance with aspects of the present invention. Steps of the method may be carried out in the environment of FIG. 4 and are described with reference to elements depicted in FIG. 4.

In embodiments, at step 701, the system (e.g., the expedited operation management device 404 of FIG. 4) utilizes IT service management tools to receive open IT operation requests (i.e., tickets). In embodiments, the IT operation requests are provided to a knowledge bank 410 that includes information associated with a set of IT operation requests, resolution resource profiles 702 (including information 703-713), and any issues predicted by a predictive analysis 716. The resolution resource profiles 702 including resolution resource information (709-713), resolution resource availability information (703-707). In particular the resolution resource information including, but not limited to, one or more of: a SME location tracker (physical location proximity to client or systems with access to the client systems of interest) 703, a SME work time zone 705 (work shift and time), and SME leave plans 707 (work calendar). The resolution resource availability information including, but not limited to, one or more of: historical ticket assignments 709, a Github check-in information (i.e., developer platform data) 711, and a total resource bandwidth 713. In embodiments, the knowledge bank 410 collects the resolution resource information on a regular basis. In embodiments, at step 715, the expedited operation management device 404, via the knowledge bank 410, tracks escalation and/or a list of parties that are contacted based on failures.

In embodiments, at step 717, the expedited operation management device 404 utilizes the data from the knowledge bank 410 for processing and selects and assigns the IT operation request to the best resolution resource 719. In embodiments, at step 721, the assigned resolution resource (i.e., one or more of the SMEs, e.g., action initiators) is notified of the new assignment. In embodiments, at step 723, should the assigned resolution resource not be available, the next best available resolution resource is assigned to the IT operation request and notified. Additionally, an action expediter, such as a contact from an escalation plan, will be notified of the change in assignment. Based on this notification of the action expediter, the newly assigned resolution resource may, be provided with additional pressure to complete the IT operation request and/or provide the newly assigned resolution resource with additional resources (e.g., additional resolution resource(s) and/or IT resources) to complete the IT operation request as needed. For example, an entire team of additional resolution resources may be provided to the newly assigned resolution resource to complete the IT operation request based on importance of the IT operation request. In embodiments, at step 725, the IT operation request and data associated with the IT operation request (e.g., status, solution, etc.) is fed (i.e., loopback) back to the knowledge bank 410 and provided to the resolution resource through the IT service management tool. For example, during the IT operation request assignment, if the SME is occupied with another IT operation request (i.e., issue/ticket), then the IT operation request will be assigned to the next best developer/team (i.e., resolution resource). The engine (i.e., IT service management device 404) continuously polls to check if the IT operation request (i.e., issue/ticket) is resolved. If not, then a check for availability of the primary SME (i.e., resolution resource) is made to re-assign the IT operation request (i.e., issue/ticket). This loopback continues until the IT operation request (i.e., issue/ticket) is resolved.

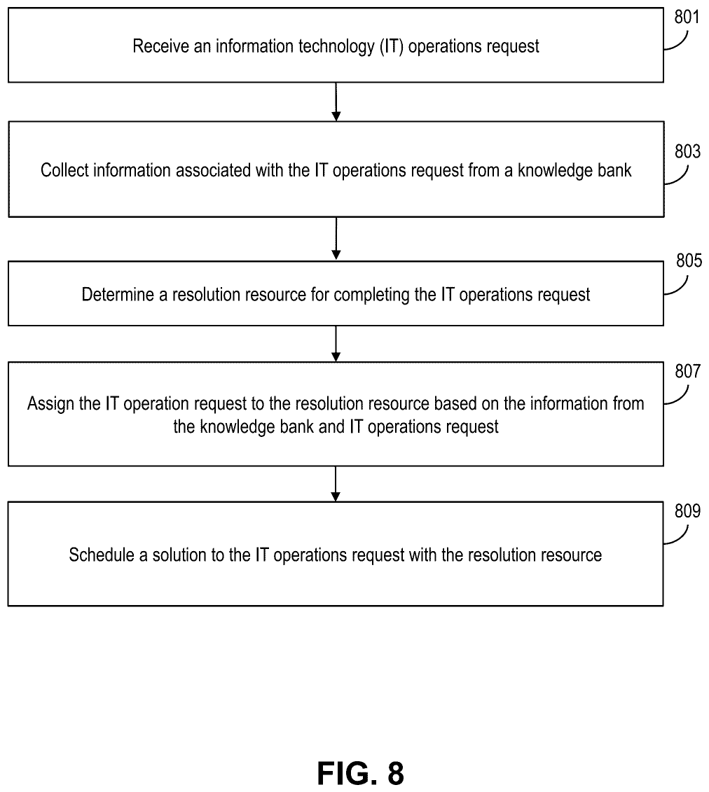

FIG. 8 shows a flowchart of an exemplary method in accordance with aspects of the present invention. Steps of the method may be carried out in the environment of FIG. 4 and are described with reference to elements depicted in FIG. 4.

In embodiments, at step 801, the system (e.g., expedited operation management device 404 of FIG. 4) receives an IT operation request. At step 803, the system collects information associated with the IT operation request from a knowledge bank 410. At step 805, the system determines a resolution resource for completing the IT operation request. At step 807, assign the IT operation request to the resolution resource based on the information from the knowledge bank 410. At step 809, the system schedules a solution to the IT operation request with the assigned resolution resource.

FIG. 9A shows a flowchart of assignments to different resolution resources in accordance with aspects of the present invention. Steps of the flowchart may be carried out in the environment of FIG. 4 and are described with reference to elements depicted in FIG. 4.

In exemplary embodiments, the progress timeline 900 shows the status of resolution of the IT operation request. At step 901, issues are identified as associated with Module 2 (Mod 2) and resolution resource information is retrieved from the knowledge base 410. The resolution resource information may include data shown in Tables 1 and 2 below.

TABLE 1
Resolution Resource Information 1

| Resolution | | | |
|---|---|---|---|
| Resource | Confidence | | Capacity |
| (RR) | Level | System Closeness | Availability |
| RR#1 | H | Near System | Not Available |
| RR#2 | M | Not with System | Available |
| RR#3 | L | With System | Available |
| RR#4 | M | With System | Available but |
| | | | Booked |

TABLE 2
Resolution Resource Information 2

| Resolution | Particular | | |
|---|---|---|---|
| Resource | Module | | |
| (RR) | Expertise | Expertise Level | Success Rate |
| RR#1 | Mod1 | H | H |
| | Mod2 | H | H |
| | Mod4 | H | M |
| RR#2 | Mod2 | M | L-M |
| | Mod3 | M | M |
| RR#3 | Mod5 | L | L-M |
| | Mod2 | L | L |
| RR#4 | Mod2 | M | M |

In exemplary embodiments, Table 1 above shows the confidence levels, system closeness, and capacity availability of the resolution resources is shown. The confidence levels may be determined by an analysis of the IT operation request to understand the issues addressed by the IT operation request. In particular, the confidence level may be based on a confidence score computation that determines, based on at least one of the issues, matching expertise of the resolution resources, expertise level in those modules, and success rates of the resolution resources on IT operation requests in those areas of expertise (as shown in Table 2 above). Additionally, Table 1 also shows the availability (including system closeness and capacity availability) of the resolution resource. The data in Table 1 may be determined from resolution resource location tracking such as a resource system closeness determined based on leave tracker, shift timings, and time zone data of the resolution resource. Further, the capacity availability may include both the total resource bandwidth (i.e., how much work the resolution resource already has on their schedule) as well as current availability to work on new IT operation requests based on shift times and calendar data such as plans for leave. Based on all of this resolution resource information from Tables 1 and 2, a multivariate analysis may be made to model/identify patterns for each of the resolution resources that indicate which resolution resource would be most suitable (i.e., best assigned if they were available) to which IT operation requests. For example, in Table 3 below, the outcome of this multivariate analysis may indicate which resolution resource is best suited and/or may be assigned (e.g., available) to the IT operation request.

TABLE 3
Resolution Resource Outcomes

| Outcome of Various | | | | |
|---|---|---|---|---|
| Results | RR#1 | RR#2 | RR#3 | RR#4 |
| Confidence Level | H | M | L | M |
| System closeness | H | L | H | H |
| Capacity Availability | L | L | H | M |
| Particular Module | H | M | L | M |
| Expertise | | | | |
| Best Suited RR | H1 | H3 | H4 | H2 |
| Practical to Assign | H3 | H2 | H1 | H2 |

In exemplary embodiments, Table 3 above shows various resolution resource information that is analyzed to generate a ranking of which of the resolution resources is best suited to resolve the IT operation request. In the example of Table 3, the most suitable resolution resource is ranked H1 and least suitable resolution resource is ranked H4. Further, a ranking is generated of assignment availability. In the example of Table 3, the most available resolution resource is ranked H1 and the least available resolution resource is ranked H3). Based on these rankings, as shown in step 903, the IT operation request is assigned to RR #3, which is available for the work and near a client system (or with access to the client systems), but has little expertise in the area of interest. However, as shown in step 905, as the expedited operation management device 404 continues to poll for changes to status of the other resolution resources (RR #1, RR #2, and RR #4), RR #2 becomes available and returns to a system near the client or with access to the client systems. Thus, at step 907, because RR #2 has some expertise in the module at issue (Mod 2), RR #2 is now assigned to the IT operation request. At step 909, the expedited operation management device 404 continues to poll for changes to status of the other resolution resources (RR #1 and RR #4). However, no changes occur as a result of the polling. Thus, the IT operation request (as shown in step 911) continues to be assigned to RR #2. At step 913, the IT operation request is assigned to RR #1 because RR #4 and RR #1 becomes available and RR #1 is best suited to resolve the IT operation request. Eventually, the progress timeline 900 ends when the status of the IT operation request is completed or resolved.

FIG. 9B shows communications between an expedited operation management device and resolution resources during the assignments in accordance with aspects of the present invention. As described above under FIG. 9A, RR #3 receives the ticket (i.e., IT operation request) after selection by the expedited operation management device 404. As the other resolution resources are continually polled and found to become available, communications from RR #1 and RR #2 communicate their availability information with the expedited operation management device (as described above with regards to steps 905 and 909 above). Thus, the ticket is sent back from RR #3 to the expedited operation management device 404 and sent to the now available RR #2 (in step 907 above) and later available RR #1 (in step 913 above).

FIG. 9C shows knowledge base information and its utilization in steps of the exemplary method in accordance with aspects of the present invention. As described in FIG. 9A above, the knowledge base 410 may include all the databases 950-952 described in FIG. 9C. However, in embodiments, these databases 950-952 may also be separately stored and managed. These databases 950-952 may include an IT operations management database 950, location tracking database 951, and shift times and leave plans database 952. In embodiments, the IT operations management database 950 may include information about IT operation requests, success rate, solution, confidence score, associated areas of expertise, etc. In embodiments, the location tracking database 951 may include information about the locations and availability of a resolution resource (i.e., the physical proximity and availability of a resolution resource) utilizing a leave tracker, shift timings, time zones, or other positioning data and locations of systems associated with a client and/or with access to a client system. In embodiments, the shift times and leave plans database 952 may include information about a work availability of a resolution resource. The work availability of the resolution resource work may include bandwidth to take on new work, working time zone, work shift times, and vacation/leave plans.

The information in databases 950-952 are used in the determinations and analysis of steps 961-969. In embodiments, at step 961, an analysis of the IT operation request is made to determine areas of expertise that may be applicable to the IT operation request. The IT operation request may be compared and matched with historical IT operation requests from the IT operations management database 950 to find similarities between the IT operation requests. These areas of expertise may be, in embodiments, at step 963, matched with resolution resource expertise and success rates of those resolution resources to calculate a particular success rate and associated confidence score for the IT operation request and each resolution resource (as shown in Table 1 above). In embodiments, at step 965, the location tracking database 951 is utilized to determine patterns of related to resolution resource elements to systems associated (physically with the client and/or with access to client systems) with a particular client of the IT operation request (as shown in Table 1 above). In embodiments, at step 967, utilizing the working availability of shift times and leave plans database 952, an analysis is performed to determine the best available resolution resource when the IT operation request is received. The best available resolution resource may further be updated based on changes to availability and incompletion of the IT operation request to find the new best available resolution resource (as shown in Table 1 above). In further embodiments, at step 969, a multivariate analysis is performed to determine solutioning patterns of the IT operation request. The multivariate analysis may utilize both the availability of the resolution resource as well as the suitability of the resolution resource to the particular IT operation request. As shown in Table 2 above, a ranking of the resolution resource may be made for suitability (i.e., if the resolution resource were available) and availability (i.e., whether resolution resource is both available to complete the IT operation request and capable of completing the IT operation request).

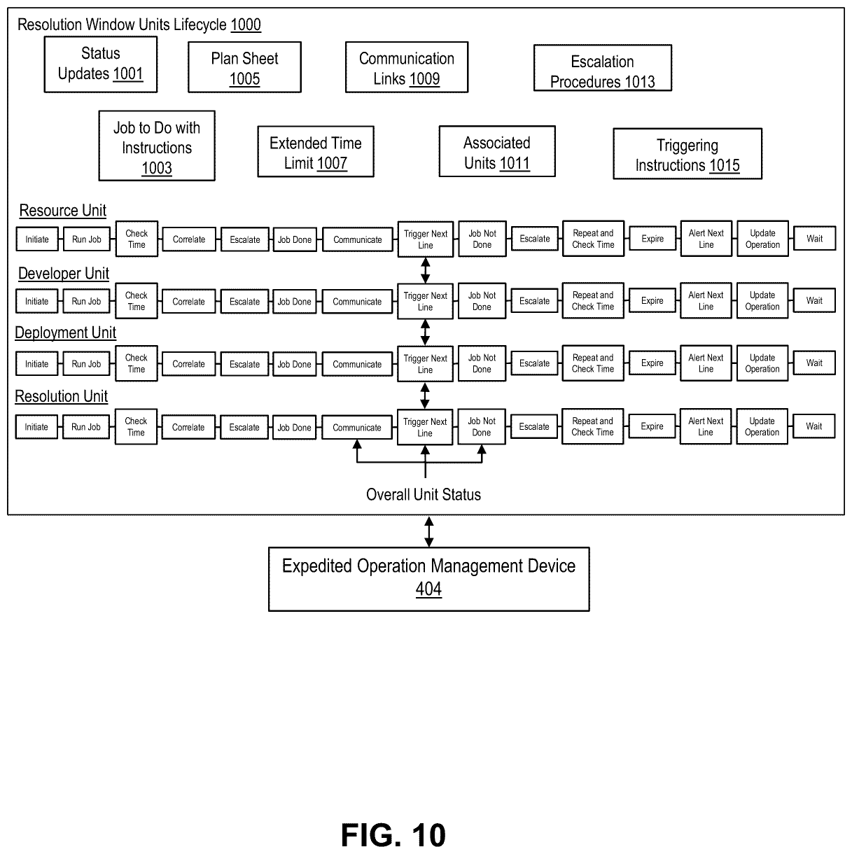

FIG. 10 shows a resolution window including resolution resource unit lifecycles in accordance with aspects of the present invention. In embodiments, the resolution window units lifecycle 1000 which include information from the expedited operation management device 404. The resolution window units lifecycle 1000 includes information about resolution resource lifecycles. The resolution resource lifecycles may include status updates 1001 of the IT operation requests, determinations of whether an IT operation request (i.e., job or ticket) is associated with instructions 1003 of the resolution resource unit, plan sheets 1005 for resolving IT operation requests by the resolution resource units, extending a time limit 1007 of the IT resolution request, communications linking 1009 to address IT operation requests (such as parties that need to be informed of statuses of the IT operation request or requests that may be made to them associated with the IT operation requests), associated units 1011 (such as parties that need to be involved in completing the IT operation request), escalation procedures (i.e., templates) 1013 for the IT operation request, and triggering instructions 1015 (i.e., when an escalation should occur, such as failure to complete within an hour). The resolution resources units include resource units, developer units, deployment units, and resolution units. Each of which may play a supervisory role to the unit above. For example, in FIG. 10, the resolution unit may be the CEO of a company that is overseeing all of the other units. Further, the resolution window units lifecycle 1000 may indicate the overall unit status of each of the units (resource unit, developer unit, deployment unit, and resolution unit) and whether escalation among the units should occur.

In another example, an IT operation request is investigated by a backend user interface (UI) team. However, as an SLA time nears (and the IT operation request remains incomplete), the units lifecycle is utilized to generate artificial intrinsic pressure. The IT operation request specifies particular adapters/plugins of an application that connects to a data source to fetch data for the application. The escalation of the IT operation request results in assignment of the IT operation request from the backend UI team to a developer application programming interface (API) team. The developer API team is identified based on known resolution resources that have worked on the API. Further, the developer API team may be narrowed to team members that worked on the particular adapter/plugin that is associated with the IT operation request. Additionally, team members associated with the data source may be identified and notified of the IT operation request if not additionally brought in to work on the IT operation request. The decision to escalate and add team members (i.e., resolution resources) is determined by the availability of the resolution resource as well as the suitability of the resolution resource to the IT operation request. If any of the team members are occupied at the time with other IT operation requests, then the next best available team member is identified and assigned to the IT operation request. As time passes and the IT operation request remains incomplete, team members may be re-assigned based on changes to availability.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computing device, an information technology (IT) operations request;
collecting, by the computing device, information associated with the IT operation request from a knowledge bank;
determining, by the computing device, a resolution resource for completing the IT operation request; and
assigning, by the computing device, the resolution resource based on the information from the knowledge bank and IT operation request.

2. The computer-implemented method of claim 1, further comprising:
determining that the resolution resource is available.

3. The computer-implemented method of claim 1, wherein the assigning of the resolution resource is also based on a prediction analysis model.

4. The computer-implemented method of claim 1, further comprising:
receiving a rejection by the resolution resource; and
assigning another resolution resource based on the information and the IT operation request.

5. The computer-implemented method of claim 1, further comprising:
verifying incompletion of the IT operation request;
determining, based on the incompletion and an escalation template, another resolution resource and another resolution resource availability for reassignment and a party for notification of the incompletion to generate an artificial intrinsic pressure for completion of the IT operation request; and
reassigning the IT operation request to the another resolution resource.

6. The computer-implemented method of claim 1, wherein the information from the knowledge bank includes at least one of:
an issue type,
an issue severity,
an expected time of response,
an impacted area,
a resolution timeline,
information associated with the resolution resource, and
an escalation template.

7. The computer-implemented method of claim 6, wherein the information associated with the resolution resource includes at least one of:
a location of the resolution resource,
a work time zone of the resolution resource,
a leave plan of the resolution resource,
historical ticket assignments of the resolution resource,
developer platform data for the resolution resource, and
a total resource bandwidth for the resolution resource.

8. The computer-implemented method of claim 1, further comprising:
generating a current state of environment of the IT operation request based on the information in the knowledge bank.

9. The computer-implemented method of claim 1, wherein the determining of the resolution resource further comprises determining a pattern associated with the resolution resource and the IT operation request.

10. The computer-implemented method of claim 1, wherein the determining of the pattern further comprises mapping information associated with the resolution resource to the IT operation request, the information associated with the resolution resource including at least one of:
application and technology skill,
historical issues,
areas of expertise,
usage statistics,
historical resolution resource skills utilized,
resolution time,
historical reassignments,
reassignment effects,
issue correlations,
interaction information,
solution application to a plurality of issues,
comparison to other resolution resource statistics,
solution approaches,
repository utilization,
client and client location,
infrastructure solution,
leave plan handling, and
time to production.

11. The computer-implemented method of claim 1, further comprising:
prioritizing the IT operation request based on a severity and business impact.

12. The computer-implemented method of claim 1, wherein the computing device includes software provided as a service in a cloud environment.

13. A computer program product comprising one or more computer readable storage media having program instructions collectively stored on the one or more computer readable storage media, the program instructions executable to:
receive an information technology (IT) operations request;
collect information associated with the IT operation request from a knowledge bank;
determine a resolution resource for completing the IT operation request;
assign the resolution resource based on the information from the knowledge bank and IT operation request; and
schedule a solution to the IT operation request with the resolution resource.

14. The computer program product of claim 13, wherein the program instructions are further executable to:
verify incompletion of the IT operation request;
determine, based on the incompletion and an escalation template, another resolution resource and another resolution resource availability for reassignment and a party for notification of the incompletion to generate an artificial intrinsic pressure for completion of the IT operation request; and
reassign the IT operation request to the another resolution resource.

15. The computer program product of claim 14, wherein the scheduling of the solution is based on scheduling information including at least one of:
urgency of rollout,
deployment type,
solution delivery type,
maintenance type, and
customer working hours.

16. The computer program product of claim 15, the program instructions are further executable to:
identify a time window for the solution based on the scheduling information.

17. A system comprising:
a processor, a computer readable memory, one or more computer readable storage media, and program instructions collectively stored on the one or more computer readable storage media, the program instructions executable to:
receive an information technology (IT) operations request;
collect information associated with the IT operation request from a knowledge bank;
generate a current state of environment of the IT operation request based on the information in the knowledge bank;
determine a resolution resource for completing the IT operation request based on at least availability of the resolution resource and the current state;
assign the resolution resource based on the information from the knowledge bank and IT operation request; and
schedule a solution to the IT operation request with the resolution resource.

18. The system of claim 17, wherein the program instructions are further executable to:
verify incompletion of the IT operation request;
determine, based on the incompletion, another resolution resource and another resolution resource availability for reassignment; and
reassign the IT operation request to the another resolution resource.

19. The system of claim 18, wherein the information from the knowledge bank includes at least one of:
an issue type,
an issue severity,
an expected time of response,
an impacted area,
a resolution timeline,
information associated with the resolution resource, and
an escalation template.

20. The system of claim 18, wherein the determining of the resolution resource further comprises determining a pattern associated with the resolution resource and IT operation request.
